(19) United States
(12) Patent Application Publication
(10) Pub. No.: US 2009/0245499 A1
(43) Pub. Date: Oct. 1, 2009

(54) CALL TRANSFER SYSTEM AND CALL TRANSFER CONTROL METHOD

(76) Inventors: Mitsuhiro WADA, Chigasaki (JP); Hirofumi MASUKAWA, Isehara (JP); Nami EI, Yokohama (JP); Yukiko TAKEDA, Tokorozawa (JP)

Correspondence Address: MATTINGLY & MALUR, P.C., 1800 DIAGONAL ROAD, SUITE 370, ALEXANDRIA, VA, 22314, US

(21) Appl. No.: 12/365,275

(22) Filed: Feb. 4, 2009

(30) Foreign Application Priority Data
Mar. 28, 2008 (JP) 2008-085522

(51) Int. Cl. H04M 3/42

(52) U.S. Cl. 379/212.01

(57) ABSTRACT

A home presence server has a storage area in which a SIP URI (hereinafter URI) of a call destination and a URI of a transfer destination are correspondingly stored. When a SIP server in a network receives a call-out request containing the URI of a first terminal being a call origination source and the URI of a second terminal being the call destination, it transfers the request to the home presence server. The home presence server acquires the URI of the transfer destination corresponding to the URI of the second terminal from the storage area, and transmits acquired URI to the SIP server. The SIP server transmits a call-out request containing the URI of the first terminal being the call origination source and the URI of a third terminal being the transfer destination, to the first terminal through a network, and the first terminal communicates with the third terminal.

### BACKGROUND OF THE INVENTION

1. Field of the Invention

The present invention relates to a call transfer system and a call transfer control method, and more particularly to a call transfer system and a call transfer control method in which the transfer of a call is controlled by employing a home presence server.

2. Description of the Related Art

Heretofore, there has been disclosed a technique wherein a presence server is installed on a carrier side and wherein a call is transferred on the basis of registered presence information (refer to, for example, Patent Document 1 being JP-A-2005-269299).

In, for example, a data transfer apparatus disclosed in Patent Document 1, when a call-out request has been received, presence information containing the information of a terminal which a call-in party can utilize is acquired. In the existence of a plurality of terminals which can be utilized, the communication terminal which is suited to the user's desire in accordance with priority levels such as a communication fee and a speech quality is selected, and a call transfer is performed.

Besides, Patent Document 2 being JP-A-2006-165723 discloses a terminal equipment which selects an IP telephone or the like service and an application in, for example, a user's house.

### SUMMARY OF THE INVENTION

With the technique disclosed in Patent Document 1, the priority levels of the speech quality and the communication fee have been set as the presence information, whereupon a call termination transfer destination among the plurality of terminals is determined according to circumstances. However, in a system having a plurality of carrier networks, a call to a terminal contracted with a certain carrier must be transferred to a terminal contracted with a different carrier, in such a way that the carriers own the personal information items of the respective terminals in common, and that they redirect the information items at network levels. Moreover, the fees of the carriers need to be totalized in one place. Nevertheless, the personal information items cannot be owned in common because the carriers are separate legal persons.

Besides, in a prior-art call transfer service or the like, in a case where a call from a terminal A to a terminal B is transferred to a terminal C, the call is sometimes terminated at the terminal B to connect a call from the terminal B being a call destination, to the terminal C. On this occasion, accounting might be imposed on the terminal B for the communication between the terminals B and C.

In view of the above drawbacks, the present invention has for its object to provide a call transfer system and a call transfer control method in which, when a call to the terminal of a certain carrier network is to be transferred to the terminal of another carrier network, the transfer of the call is realized under the condition that the carriers do not own personal information items in common. Another object of the invention is to provide a call transfer system and a call transfer control method in which, when a call from a terminal A to a terminal B of certain carrier network is to be transferred to a terminal C of another carrier network, a communication is performed without imposing accounting on the terminal B.

According to the invention, an individual having a plurality of telephone terminals installs a home server in a subscriber's house, and regarding the plurality of terminals such as a fixed telephone and a portable telephone which are respectively contracted with separate carriers, the individual who is a subject for the contracts registers presence information items on terminal information items into the home server, under self-responsibility by the PC, the telephone terminal or the like beforehand. The home server manages personal information items in which the information items of the contracts with the different carriers coexist, and it extracts the presence information for a call-out from a carrier network, so as to realize the redirection between the terminals contracted with the different carriers.

By way of example, a home presence server information transfer control system installs an IP fixed telephone and the home server having a presence function, within the subscriber's house which is connected to an Internet protocol (IP) network employing a session initiation protocol (SIP). The individual registers the presence information items on the information items of the plurality of terminals such as the telephones, owned by the individual, into the server, and any call from the carrier network to a call termination is interworked on the home presence server in accordance with the registered information, so as to be redirected to the terminal contracted with the different carrier.

Besides, the home presence server information transfer control system stated above is so operated that, in a case where the fixed telephone installed in the subscriber's house has been called up from the carrier network and where a response is nonexistent for a certain specified time, the redirection is performed in accordance with the presence information registered in the home presence server.

The home presence server information transfer control system stated above is so operated that, in a case where a call has been originated from a calling telephone terminal with the telephone number of a called-destination fixed telephone as is endowed with a specified telephone number, the home presence server is called out from the carrier network, and the redirection is performed in accordance with the presence information of the home presence server.

In addition, the home presence server information transfer control system stated above is so operated that, in a case where the fixed telephone installed in the subscriber's house has been called up from the carrier network, call-out is monitored by the home presence server, the call-up to the fixed telephone is canceled, and the redirection is performed in accordance with the presence information registered in the home presence server.

According to the first solving means of this invention, there is provided a call transfer system for transferring a call for a first terminal which communicates with a first carrier network, to a second terminal which communicates with a second carrier network, comprising:

a home server which has a presence information storage area where identification information of the first terminal being a call destination and identification information of the second terminal being a transfer destination are stored in correspondence; and

a call control server which has a server information storage area where identification information of said home server is stored in correspondence with the identification information of the first terminal, and which performs a call control;

wherein said call control server receives a first call-out request which contains identification information of a third terminal being a call origination source and the identification information of the first terminal being the call destination;

said call control server specifies said home server corresponding to the identification information of the first terminal, with reference to the server information storage area, and transmits the identification information of the first terminal being the call destination to said home server;

said home server refers to the presence information storage area on the basis of the received identification information of the first terminal, to acquire corresponding identification information of the second terminal being the transfer destination, and transmits acquired identification information of the second terminal to said call control server;

said call control server receives the identification information of the second terminal, and transmits a second call-out request which contains the identification information of the third terminal being the call origination source and the identification information of the second terminal being the transfer destination, to the second terminal through the second carrier network; and

communication is performed between the second terminal being the call destination which has received the second call-out request and the third terminal being the call origination source.

According to the second solving means of this invention, there is provided a call transfer system for transferring a call for a first terminal which communicates with a first carrier network, to a second terminal which communicates with a second carrier network, comprising:

a home server which has a presence information storage area where identification information of the first terminal being a call destination and identification information of the second terminal being a transfer destination are stored in correspondence, and which monitors existence of a call-out request for the first terminal; and

a call control server which performs a call control;

wherein

said call control server transfers a first call-out request which contains identification information of a third terminal being a call origination source and the identification information of the first terminal being the call destination, to the first terminal in accordance with the identification information of the first terminal being the call destination;

when said home server detects the first call-out request for the first terminal, said home server refers to the presence information storage area on the basis of the identification information of the first terminal being the call destination which is contained in the first call-out request, to acquire the identification information of corresponding second terminal being the transfer destination, and transmits acquired identification information of the second terminal to said call control server;

said call control server receives the identification information of the second terminal, and transmits a second call-out request which contains the identification information of the third terminal being the call origination source and the identification information of the second terminal being the transfer destination, to the second terminal through the second carrier network; and

communication is performed between the second terminal being the call destination which has received the second call-out request and the third terminal being the call origination source.

According to the third solving means of this invention, there is provided a call transfer control method for transferring a call for a first terminal which communicates with a first carrier network, to a second terminal which communicates with a second carrier network, comprising the steps of:

allowing a call control server to receive a first call-out request which contains identification information of a third terminal being a call origination source and identification information of the first terminal being a call destination;

allowing the call control server to refer to a server information storage area where identification information of a home server is stored in correspondence with the identification information of the first terminal, to specify the home server which corresponds to the identification information of the first terminal being the call destination, and to transmit the identification information of the first terminal being the call destination, to the home server;

allowing the home server to refer to a presence information storage area where the identification information of the first terminal being the call destination and identification information of the second terminal being a transfer destination are stored in correspondence, on the basis of the received identification information of the first terminal, to acquire corresponding identification information of the second terminal being the transfer destination, and to transmit acquired identification information of the second terminal to the call control server;

allowing the call control server to receive the identification information of the second terminal, and to transmit a second call-out request which contains the identification information of the third terminal being the call origination source and the identification information of the second terminal being the transfer destination, to the second terminal through the second carrier network; and

performing communication between the second terminal being the call destination which has received the second call-out request and the third terminal being the call origination source.

According to the fourth solving means of this invention, there is provided a call transfer control method for transferring a call for a first terminal which communicates with a first carrier network, to a second terminal which communicates with a second carrier network, comprising the steps of:

allowing a call control server to transfer a first call-out request which contains identification information of a third terminal being a call origination source and identification information of the first terminal being a call destination, to the first terminal in accordance with the identification information of the first terminal being the call destination;

allowing a home server, when the home server detects the first call-out request for the first terminal, to refer to a presence information storage area where the identification information of the first terminal being the call destination and identification information of the second terminal being a transfer destination are stored in correspondence, on the basis of the identification of the first terminal being the call destination which is contained in the first call-out request, to acquire corresponding identification information of the second terminal being the transfer destination, and to transmit acquired identification information of the second terminal to the call control server;

allowing the call control server to receive the identification information of the second terminal, and to transmit a second call-out request which contains the identification information of the third terminal being the call origination source and the identification information of the second terminal being the transfer destination, to the second terminal through the second carrier network; and

performing communication between the second terminal being the call destination which has received the second call-out request and the third terminal being the call origination source.

According to the present invention, it is possible to provide a call transfer system and a call transfer control method in which, when a call to the terminal of a certain carrier network is to be transferred to the terminal of another carrier network, the transfer of the call is realized under the condition that the carriers do not own personal information items in common. According to the invention, it is possible to provide a call transfer system and a call transfer control method in which, when a call from a terminal A to a terminal B of certain carrier network is to be transferred to a terminal C of another carrier network, a communication is performed without imposing accounting on the terminal B.

### BRIEF DESCRIPTION OF THE DRAWINGS

FIG. 1 is a conceptual diagram of the configuration of the whole home presence server connection network;

FIG. 2 is conceptual diagram of the configuration of a subscriber's house network;

FIG. 3 is a format diagram of a presence information management table;

FIG. 4 is a diagram of a carrier side redirection control sequence (1);

FIG. 5 is a diagram of a carrier side redirection control sequence (2);

FIG. 6 is a diagram of a carrier side redirection control sequence (3);

FIG. 7 is a diagram for explaining a presence information registration method; and

FIG. 8 is a format diagram of a terminal server correspondence table.

### DESCRIPTION OF THE PREFERRED EMBODIMENT

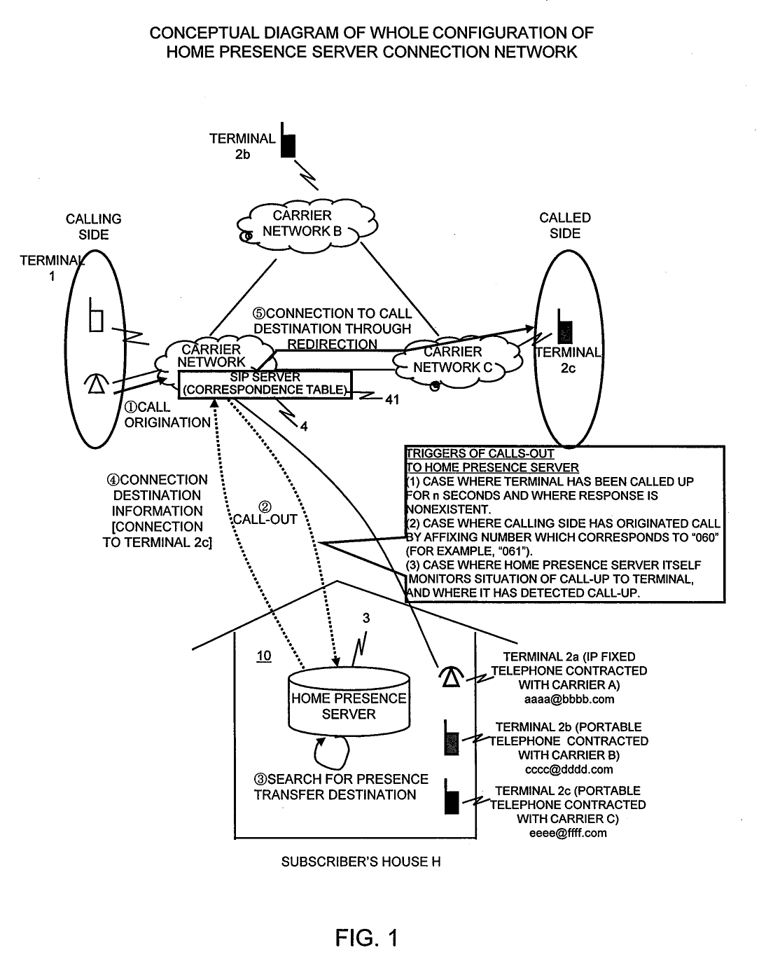

FIG. 1 is a diagram of the whole configuration of a home presence server connection network.

The network (call transfer system) includes, for example, a home presence server (home server) 3, and a SIP server (call control server) 4. Besides, the system has a terminal (first terminal) 2a contracted with a carrier network A, a terminal 2b contracted with a carrier network B, and a terminal (second terminal) 2c contracted with a carrier network C. By way of example, the terminal 2a is an IP fixed telephone, and the terminals 2b and 2c are portable telephone terminals. In this system, the SIP server 4 is installed in the carrier network A.

The home presence server 3 is installed in a subscriber's house, and the IP fixed telephone terminal 2a contracted with the carrier network A (hereinbelow, simply termed the “terminal 2a” or “IP fixed telephone 2a” in some cases) is also installed in the subscriber's house. The identification information of the terminal of a transfer destination is stored in the home presence server 3 beforehand. The SIP server 4 is a server which performs a call control in accordance with a session initiation protocol (SIP). The corresponding relations the terminal 2a, etc. and the home presence server 3 are stored in the SIP server 4. Incidentally, although the SIP is employed in this embodiment, any other appropriate call control protocol may well be employed.

In the pertinent home (or user), there are used the telephone terminals contracted with the plurality of carriers, such as the portable telephone terminal 2b contracted with the carrier network B (hereinbelow, simply termed the “terminal 2b” in some cases) and the portable telephone terminal 2c contracted with the carrier network C (hereinbelow, simply termed the “terminal 2c” in some cases). The portable telephone terminal 2b communicates with the carrier network B through an access point or the like within the house or in a place where the user has gone. The portable telephone terminal 2c communicates with the carrier network C through an access point or the like within the house or in a place where the user has gone.

First, when a terminal (third terminal) 1 on a calling side has called out the terminal 2a, the home presence server 3 is called up by the SIP server 4 of the carrier network A. A contractor himself/herself within the subscriber's house registers the data of the telephone terminals which are to be called up when called out by the carrier networks, into the home presence server 3 as the presence information items beforehand. A chance at which the carrier network calls out (accesses) the home presence server 3, and a chance at which the home presence server 3 detects the call-out to the terminal 2a, occur in, for example, cases indicated below. Incidentally, detailed processes will be stated later.

(1) Case where the terminal 1 on the calling side has called up the IP fixed telephone 2a of a designated destination for n seconds, and where a response is nonexistent.

(2) Case where the terminal 1 on the calling side has originated a call by affixing a predetermined unique number such as a number corresponding to “060” (for example, “061”) for the FMC.

(3) Case where the home presence server 3 itself monitors the situation of call-up to the terminal 2a, and where it has detected the call-up.

With a key being the telephone number or SIP URI of the IP fixed telephone terminal 2a for which a call-out request has been made, the home presence server 3 extracts the telephone number or the SIP URI of the terminal (for example, the portable telephone terminal 2c) being the transfer destination which has been registered as the presence information beforehand. Besides, the home presence server 3 sends a response back to the SIP server 4 of the carrier network A as redirection information. The SIP server 4 of the carrier network A calls out the portable telephone terminal 2c of the carrier network C by using a redirection function. Thus, the communications between the terminal 1 on the calling side and the terminal 2c are permitted. Incidentally, although one subscriber's house is illustrated in FIG. 1, the call transfer system can include a plurality of subscriber's houses, and the SIP server 4 of the carrier network A can communicate with a plurality of home presence servers 3 included in the respective subscriber's houses.

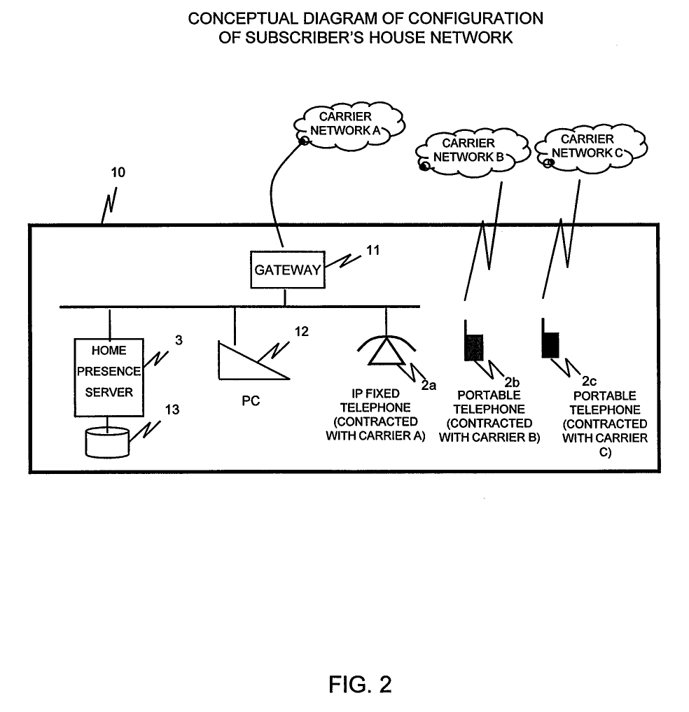

FIG. 2 is a conceptual diagram of the configuration of a subscriber's house network.

The subscriber's house network 10 includes an IP network in which the IP fixed telephone 2a, for example, communicates, and a radio network in which the portable telephones 2b and 2c communicate. The IP network has, for example, a gateway 11, the home presence server 3 in which presence information is stored, a PC 12 which is capable of rewriting the presence information, and the IP fixed telephone 2a, and the respective constituents are connected by a local area network (LAN). Besides, the IP network has a storage area in which a presence information management table 13 is stored. Incidentally, the presence information management table 13 may well be included in the home server. By the way, the respective portable telephones perform call originations and terminations between them and the carriers with which they are contacted.

The home presence server 3 may be an independent server as shown in FIG. 2, or by way of example, the home presence server 3 and the gateway 11 may well be configured of one apparatus. Besides, the home presence server 3 and the terminal 2a may well be configured of one apparatus. In addition, the home presence server 3 is managed by the owner, contractor or the like of the terminal 2a or the like.

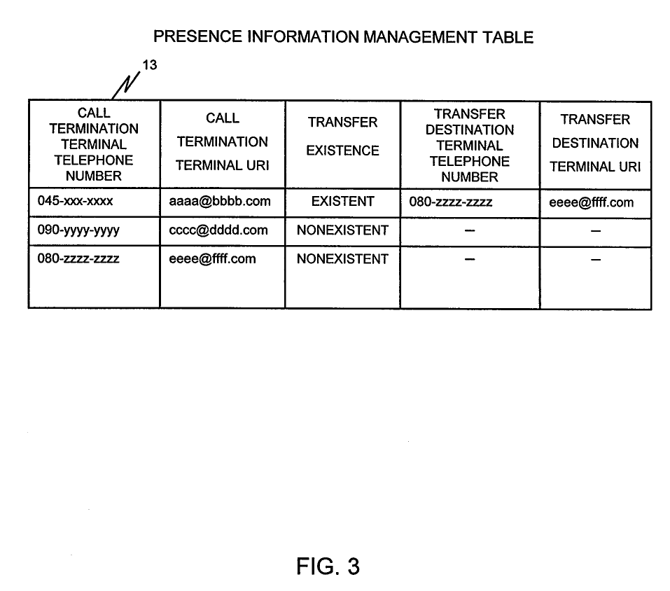

FIG. 3 is a format diagram of the presence information management tale 13.

In the presence information management table (presence information storage area) 13, transfer existence information, and transfer destination telephone numbers and/or transfer destination URIs are registered in correspondence with, for example, call destination telephone numbers and/or call destination URIs (for example, SIP URIs). In the example of FIG. 3, in correspondence with the telephone number (045-xxx-xxxx) and terminal URI (aaaa@bbbb.com) of the IP fixed telephone 2a, transfer “existent” is stored as the transfer existence information, while the telephone number (080-zzzz-zzzz) and URI (eeee@ffff.com) of the portable telephone terminal 2c are respectively stored as the telephone number of the transfer destination terminal and the URI thereof. In this embodiment, the individual information items which are stored in the presence information management table 13 are stored through a predetermined terminal or the like by the user, and they are referred to by the home presence server 3 which is installed within the house, so that the personal information items need not be shared by the plurality of carriers. Incidentally, both the telephone number and the URI may be stored, or either of them may well be stored. Although the telephone number and the URI are employed in this embodiment, appropriate identification information which identifies the terminal or the home presence server may well be employed.

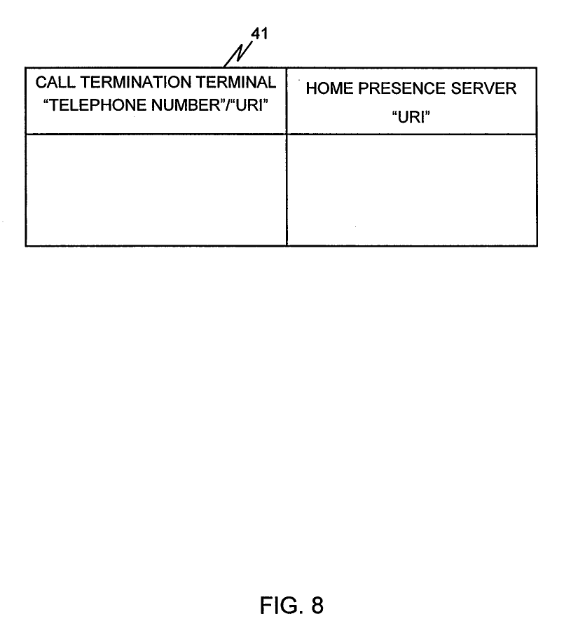

FIG. 8 is a format diagram of a terminal server correspondence table 41.

In the terminal server correspondence table (server information storage area) 41, the SIP URI of the home presence server 3 is stored in correspondence with, for example, the telephone number or SIP URI of the call termination terminal beforehand. By way of example, the manager of the carrier network A may register the individual information items, or the user who possesses the home presence server 3 may well register them from the terminal 2a, the PC 12, another terminal or the like.

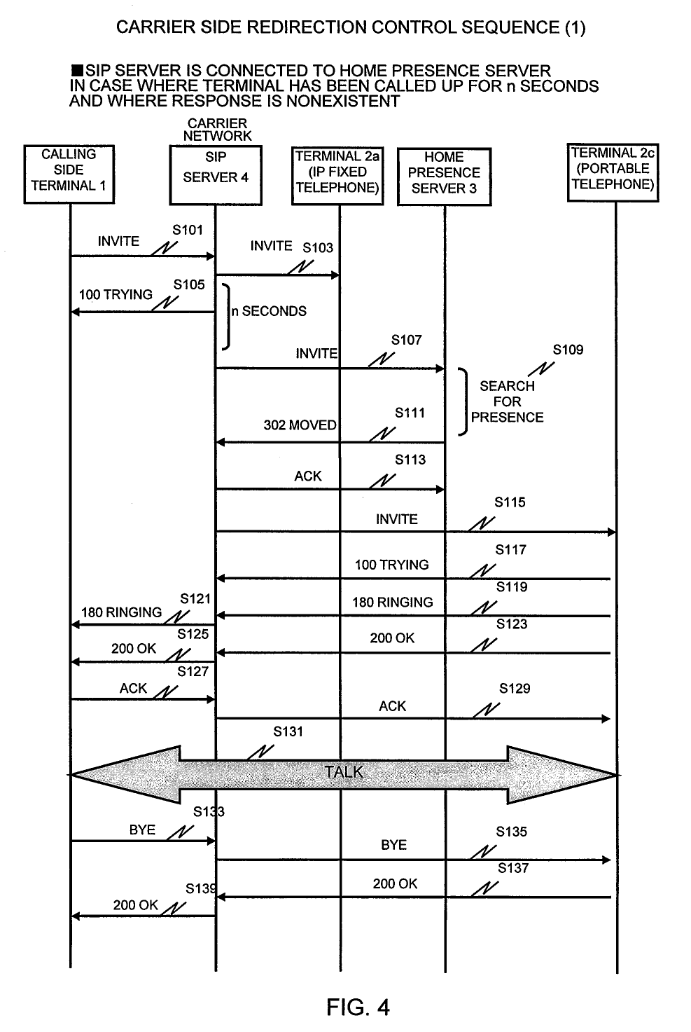

FIG. 4 is a sequence diagram (1) of a carrier side redirection control.

First, there will be described an operating example in which the SIP server 4 is connected to the home presence server 3 with a chance being the case where the IP fixed telephone 2a has been called up for n seconds and where the response of the IP fixed telephone 2a is nonexistent.

First, the terminal (for example, user telephone terminal) 1 calls up the telephone number or SIP URI of the IP fixed telephone 2a contracted with the carrier network A (S101). By way of example, the terminal 1 transmits an INVITE message (first call-out request) which contains the SIP URI (identification information) of its own terminal 1 being a call origination source and the SIP URI of the IP fixed telephone 2a being a call destination, to the SIP server 4 in accordance with the SIP. It is assumed that the user of the terminal 1 knows the telephone number or SIP URI of the IP fixed telephone 2a beforehand. Incidentally, the telephone number and the SIP URI are held in correspondence, and one of the telephone number and the SIP URI can be specified from the other in such a way that any appropriate server or any appropriate storage area in which telephone numbers and SIP URIs are stored in correspondence is referred to at any appropriate timing.

The SIP server 4 of the carrier network A as has received the call-up, calls up the IP fixed telephone 2a in the subscriber's house H (S103). By way of example, the SIP server 4 transmits an INVITE message to the IP fixed telephone 2a in accordance with the SIP URI of the call destination of the received INVITE message. Here, the IP fixed telephone 2a is called up. Incidentally, the SIP server 4 transmits a 100 trying message to the terminal 1 in accordance with the SIP (S105).

In the case where the IP fixed telephone 2a does not respond and where the response is not existent in spite of the call-up for n seconds, the SIP server 4 of the carrier network A calls out the home presence server 3 in the subscriber's house H (S107). Incidentally, the call-up time n can be previously determined. In correspondence with the SIP URI or telephone number of the terminal 2a, the SIP URI of the home presence server 3 is registered in the terminal server correspondence table 41 of the SIP server 4 beforehand. By way of example, the SIP server 4 acquires the SIP URI of the corresponding home presence server 3 on the basis of the SIP URI or telephone number of the IP fixed telephone 2a being the call destination as is contained in the INVITE message received from the terminal 1, and it transmits an INVITE message to the home presence server 3, with the acquired SIP URI as a destination. On this occasion, the SIP server 4 affixes the SIP URI or telephone number of the IP fixed telephone 2a being the call destination, to the INVITE message for the home presence server 3. By way of example, the SIP server 4 can contain the SIP URI (aaaa@bbbb.com) of the IP fixed telephone 2a being the call destination, in the predetermined field of the message.

The home presence server 3 receives the INVITE message from the SIP server 4. This home presence server 3 searches the presence information management table 13 with the key being the SIP URI or telephone number of the IP fixed telephone 2a as is affixed to the INVITE message, and it extracts the SIP URI or telephone number of the corresponding telephone terminal as the transfer destination (S109). In the example of the process information management table 13 as shown in FIG. 3, the SIP URI (eeee@ffff.com) of the portable telephone terminal 2c is acquired.

The home presence server 3 sends back the SIP URI or telephone number of the transfer destination as acquired as the call-out response from the SIP server 4 of the carrier network A (here, the SIP URI of the portable telephone terminal 2c), to the SIP server 4 as redirection information (S111). By way of example, the home presence server 3 contains the acquired SIP URI or telephone number of the transfer destination in a 302 Moved message of the SIP and transmits the message to the SIP server 4 (number alteration request). Incidentally, the SIP server 4 may well give back an ACK to the home presence server 3 (S113).

The SIP server 4 of the carrier network A calls up the portable telephone terminal 2c through the carrier network C on the basis of the received redirection information (S115). Byway of example, the SIP server 4 receives the SIP URI or telephone number of the portable telephone terminal 2c as the redirection information. Besides, the SIP server 4 transmits an INVITE message (second call-out request) which contains, for example, the SIP URI of the terminal 1 being the call origination source and the received SIP URI of the portable telephone terminal 2c being the transfer destination, to the portable telephone terminal 2c through the carrier network C. By the way, in a case where the telephone number of the transfer destination has been received, the corresponding SIP URI is appropriately acquired.

In a case where the portable telephone terminal 2c has been called up in accordance with the INVITE message and where this portable telephone terminal 2c has responded, speech is made between the terminal 1 and the portable telephone terminal 2c (S117-S131). When a conversation has ended, a connection end notice (for example, BYE message) is transmitted from one terminal (for example, the calling side terminal 1) to the other terminal (for example, the terminal 2c), and the speech is cut off (S133-S139). Incidentally, 180 Ringing messages, 200 OK messages, ACK messages, etc. are transmitted and received in accordance with the SIP as shown in FIG. 4, but they shall be omitted from detailed description.

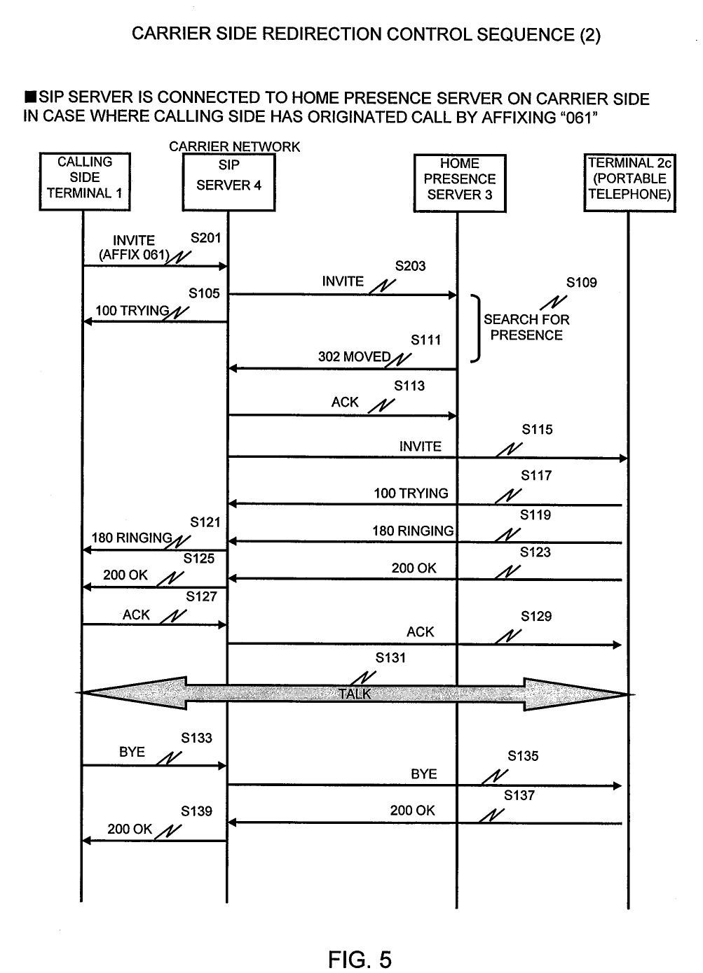

FIG. 5 is a sequence diagram (2) of the carrier side redirection control.

Next, there will be described an operating example in which the calling side terminal 1 originates a call by affixing a unique number “0XY” (for example, “061”) and in which the home presence server 3 is connected by the carrier side. Incidentally, the unique number can be previously determined.

The terminal 1 calls up the IP fixed telephone 2a being the call destination and contracted with the carrier network A, by affixing the unique number to the telephone number of the IP fixed telephone 2a (S201).

The SIP server 4 of the carrier network A as has received the call-up calls out the home presence server 3 in the subscriber's house H for the reason that the unique number is affixed (S203). More concretely, the telephone number of the home presence server 3 in the subscriber's house H is first specified from the telephone number of the IP fixed telephone 2a being the call destination. In correspondence with the telephone number of the terminal 2a, the SIP URI of the home presence server 3 is registered in the terminal server correspondence table 41 of the SIP server 4 beforehand. By way of example, the SIP server 4 acquires the corresponding SIP URI of the home presence server 3 by referring to the terminal server correspondence table 41, and on the basis of the telephone number part of the IP fixed telephone being the call destination as removes the unique number from the telephone number received from the terminal 1. The SIP server 4 transmits an INVITE message to the home presence server 3 by setting the acquired SIP URI as a destination. On this occasion, the SIP server 4 affixes the telephone number of the IP fixed telephone 2a being the call destination, to the INVITE message for the home presence server 3. By way of example, the SIP server 4 can contain the telephone number of the IP fixed telephone 2a being the call destination, into the predetermined field of the message. Incidentally, the SIP URI of the IP fixed telephone 2a may well be affixed to the INVITE message to the home presence server 3, in such a way that a storage area in which the corresponding relation between the telephone number and SIP URI of the IP fixed telephone 2a is stored beforehand is referred to, and that the SIP URI is obtained from the telephone number. Besides, the SIP server 4 transmits a 100 trying message to the terminal 1 in accordance with the SIP (S105).

Since the subsequent processing is the same as described before, the identical step numbers are assigned, and they shall be outlined and omitted from detailed description.

The home presence server 3 searches the presence information management table 13 with a key being the telephone number or SIP URI of the IP fixed telephone 2a, thereby to extract the telephone number or SIP URI of the portable telephone terminal 2c as a transfer destination (S109).

The home presence server 3 sends back the telephone number or SIP URI of the portable telephone terminal 2c being the transfer destination as acquired as the call-out response from the SIP server 4 of the carrier network A, to the SIP server 4 as redirection information (S111).

The SIP server 4 of the carrier network A calls up the portable telephone terminal 2c through the carrier network C on the basis of the received redirection information (S115). In a case where the portable telephone terminal 2c has been called up in accordance with an INVITE message and where this portable telephone terminal 2c has responded, speech is made between the terminal 1 and the portable telephone terminal 2c (S117-S131). When a conversation has ended, a connection end notice is transmitted from the calling side terminal 1 to the portable telephone terminal 2c, and the speech is cut off (S133-S139).

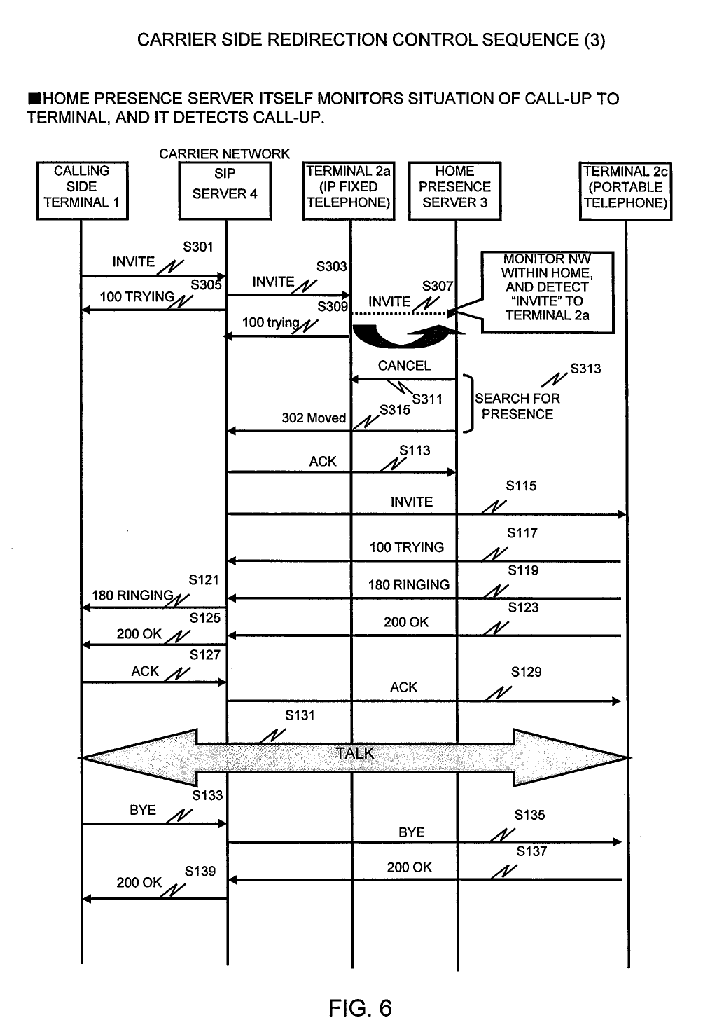

FIG. 6 is a sequence diagram (3) of the carrier side redirection control.

Next, there will be described an operating example in which the home presence server 3 itself monitors the situation of call-up to the terminal 2a, and in which it has detected the call-up.

The terminal 1 calls up the telephone number or SIP URI of the IP fixed telephone 2a contracted with the carrier network A (S301). By way of example, the terminal 1 transmits an INVITE message (first call-out request) which contains the SIP URI (identification information) of its own terminal 1 being a call origination source and the SIP URI of the terminal 2a being a call destination, to the SIP server 4 in accordance with the SIP.

The SIP server 4 of the carrier network A as has received the call-out, calls up the IP fixed telephone 2a in the subscriber's house H (S303). By way of example, the SIP server 4 transmits an INVITE message to the IP fixed telephone 2a in accordance with the SIP URI of the call destination of the received INVITE message. By the way, in accordance with the SIP, the SIP server 4 transmits a 100 trying message to the terminal 1 (S305), and the IP fixed telephone 2a transmits a 100 trying message to the SIP server 4 (S309).

The home presence server 3 which is connected on the same LAN as that of the IP fixed telephone 2a in the subscriber's house H, is always monitoring a call termination signal for the IP fixed telephone 2a, and it detects a call termination to the IP fixed telephone 2a (S307). When the home presence server 3 detects the call termination to the IP fixed telephone 2a, it commands the IP fixed telephone 2a to cancel the call-up (S311).

The home presence server 3 searches the presence information management table 13 with a key being the telephone number or SIP URI of the IP fixed telephone 2a, thereby to extract the telephone number or SIP URI of the corresponding portable telephone terminal 2c as a transfer destination (S313). By the way, in a case where the corresponding transfer existence information of the presence information management table 13 is “transfer nonexistent”, the call may well be terminated to the IP fixed telephone 2a again. By way of example, the home presence server 3 may transmit an INVITE message to the IP fixed telephone 2a, or this home presence server 3 may well request the SIP server 4 to resend the INVITE message to the IP fixed telephone 2a. Besides, the home presence server 3 may well refer to the transfer existence information of the presence information management table 13 before the above command (S311) for canceling the call-up, so as to execute the above step S311 in case of “transfer existent” and to omit the processing of the steps S311 et seq. in case of “transfer nonexistent”.

The home presence server 3 sends back the telephone number or SIP URI of the portable telephone terminal 2c as extracted as the call-out response from the SIP server 4 of the carrier network A, to the SIP server 4 as redirection information (S315). By way of example, the home presence server 3 transmits a 302 Moved message of SIP to the SIP server 4 by containing the SIP URI or telephone number of the acquired transfer destination (number alteration request).

Since the subsequent processing is the same as described before, the identical step numbers are assigned, and they shall be outlined and omitted from detailed description.

The SIP server 4 of the carrier network A calls up the portable telephone terminal 2c through the carrier network C on the basis of the received redirection information (S115). In a case where the portable telephone terminal 2c has been called up in accordance with an INVITE message and where this portable telephone terminal 2c has responded, speech is made between the terminal 1 and the portable telephone terminal 2c (S117-S131). When a conversation has ended, a connection end notice is transmitted from the calling side terminal 1 to the portable telephone terminal 2c, and the speech is cut off (S133-S139).

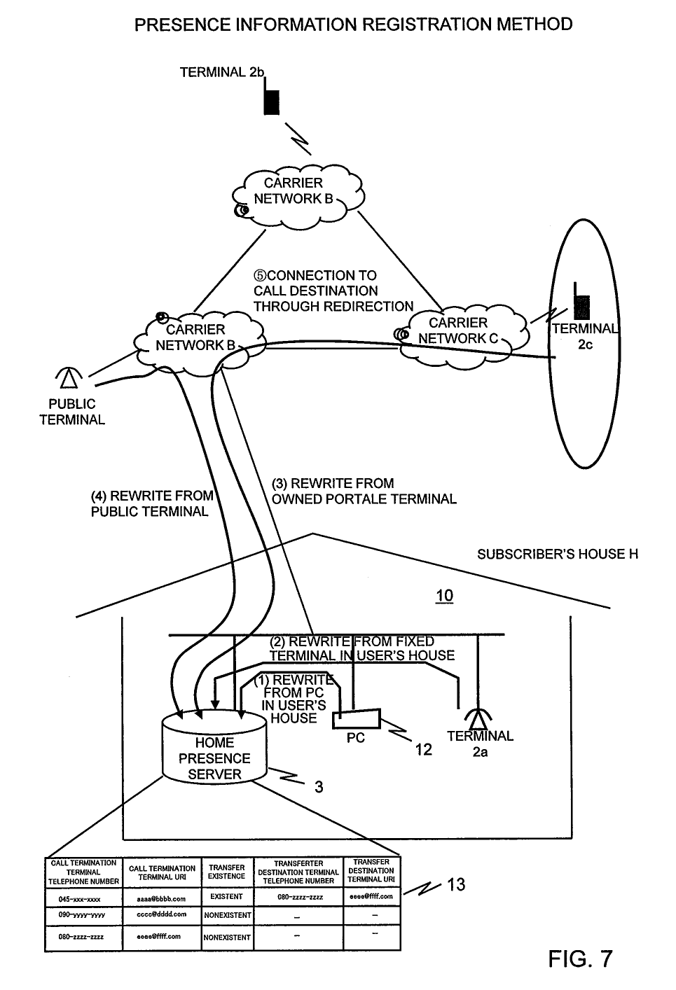

FIG. 7 is a diagram for explaining a presence information registration method.

As methods for registering presence information into the home presence server 3 and updating the presence information, there are the following examples:

(1) The presence information is registered and updated from the PC 12 on the LAN of the subscriber's house H.

(2) The presence information is registered and updated from the IP fixed telephone 2a on the LAN of the subscriber's house H.

(3) The presence information is registered and updated through the carrier network from the owned portable telephone terminal 2b or 2c.

(4) The presence information is registered and updated through the carrier network from a public telephone terminal. Incidentally, the home presence server 3 may well be subjected to such an access limitation that this home presence server cannot be accessed by any terminal other than the PC 12 and the terminal 2a, 2b or 2c or any person other than the owners of these terminals.

The present invention is applicable to, for example, an IP network having a plurality of carrier networks.

What is claimed is:

1. A call transfer system for transferring a call for a first terminal which communicates with a first carrier network, to a second terminal which communicates with a second carrier network, comprising:
a home server which has a presence information storage area where identification information of the first terminal being a call destination and identification information of the second terminal being a transfer destination are stored in correspondence; and
a call control server which has a server information storage area where identification information of said home server is stored in correspondence with the identification information of the first terminal, and which performs a call control;
wherein said call control server receives a first call-out request which contains identification information of a third terminal being a call origination source and the identification information of the first terminal being the call destination;
said call control server specifies said home server corresponding to the identification information of the first terminal, with reference to the server information storage area, and transmits the identification information of the first terminal being the call destination to said home server;
said home server refers to the presence information storage area on the basis of the received identification information of the first terminal, to acquire corresponding identification information of the second terminal being the transfer destination, and transmits acquired identification information of the second terminal to said call control server;
said call control server receives the identification information of the second terminal, and transmits a second call-out request which contains the identification information of the third terminal being the call origination source and the identification information of the second terminal being the transfer destination, to the second terminal through the second carrier network; and
communication is performed between the second terminal being the call destination which has received the second call-out request and the third terminal being the call origination source.

2. A call transfer system as defined in claim 1, wherein
when said call control server receives the first call-out request, said call control server transfers the first call-out request to the first terminal in accordance with the identification information of the first terminal being the call destination and, in a case where a response is nonexistent in spite of call-up of the first terminal for a predetermined time, said call control server transmits the identification information of the first terminal to specified home server.

3. A call transfer system as defined in claim 1, wherein:
the first call-out request further contains a predetermined unique number; and
when said call control server receives the first call-out request containing the unique number, said call control server transmits the identification information of the first terminal being the call destination which is contained in the first call-out request, to specified home server.

4. A call transfer system for transferring a call for a first terminal which communicates with a first carrier network, to a second terminal which communicates with a second carrier network, comprising:
a home server which has a presence information storage area where identification information of the first terminal being a call destination and identification information of the second terminal being a transfer destination are stored in correspondence, and which monitors existence of a call-out request for the first terminal; and
a call control server which performs a call control;
wherein
said call control server transfers a first call-out request which contains identification information of a third terminal being a call origination source and the identification information of the first terminal being the call destination, to the first terminal in accordance with the identification information of the first terminal being the call destination;
when said home server detects the first call-out request for the first terminal, said home server refers to the presence information storage area on the basis of the identification information of the first terminal being the call destination which is contained in the first call-out request, to acquire the identification information of corresponding second terminal being the transfer destination, and transmits acquired identification information of the second terminal to said call control server;
said call control server receives the identification information of the second terminal, and transmits a second call-out request which contains the identification information of the third terminal being the call origination source and the identification information of the second terminal being the transfer destination, to the second terminal through the second carrier network; and
communication is performed between the second terminal being the call destination which has received the second call-out request and the third terminal being the call origination source.

5. A call transfer system as defined in claim 4, wherein when said home server detects the first call-out request, said home server commands the first terminal to cancel the call-out.

6. A call transfer system as defined in claim 1, wherein said home server and the first terminal are connected by a customer premise network.

7. A call transfer system as defined in claim 1, comprises a plurality of the home servers for each subscriber.

8. A call transfer system as defined in claim 1, wherein said home server is managed by an owner of the first terminal and the second terminal.

9. A call transfer system as defined in claim 4, wherein said home server and the first terminal are connected by a customer premise network.

10. A call transfer system as defined in claim 4, comprises a plurality of the home servers for each subscriber.

11. A call transfer system as defined in claim 4, wherein said home server is managed by an owner of the first terminal and the second terminal.

12. A call transfer control method for transferring a call for a first terminal which communicates with a first carrier network, to a second terminal which communicates with a second carrier network, comprising the steps of:
allowing a call control server to receive a first call-out request which contains identification information of a third terminal being a call origination source and identification information of the first terminal being a call destination;
allowing the call control server to refer to a server information storage area where identification information of a home server is stored in correspondence with the identification information of the first terminal, to specify the home server which corresponds to the identification information of the first terminal being the call destination, and to transmit the identification information of the first terminal being the call destination, to the home server;
allowing the home server to refer to a presence information storage area where the identification information of the first terminal being the call destination and identification information of the second terminal being a transfer destination are stored in correspondence, on the basis of the received identification information of the first terminal, to acquire corresponding identification information of the second terminal being the transfer destination, and to transmit acquired identification information of the second terminal to the call control server;
allowing the call control server to receive the identification information of the second terminal, and to transmit a second call-out request which contains the identification information of the third terminal being the call origination source and the identification information of the second terminal being the transfer destination, to the second terminal through the second carrier network; and
performing communication between the second terminal being the call destination which has received the second call-out request and the third terminal being the call origination source.

13. A call transfer control method for transferring a call for a first terminal which communicates with a first carrier network, to a second terminal which communicates with a second carrier network, comprising the steps of:
allowing a call control server to transfer a first call-out request which contains identification information of a third terminal being a call origination source and identification information of the first terminal being a call destination, to the first terminal in accordance with the identification information of the first terminal being the call destination;
allowing a home server, when the home server detects the first call-out request for the first terminal, to refer to a presence information storage area where the identification information of the first terminal being the call destination and identification information of the second terminal being a transfer destination are stored in correspondence, on the basis of the identification of the first terminal being the call destination which is contained in the first call-out request, to acquire corresponding identification information of the second terminal being the transfer destination, and to transmit acquired identification information of the second terminal to the call control server;
allowing the call control server to receive the identification information of the second terminal, and to transmit a second call-out request which contains the identification information of the third terminal being the call origination source and the identification information of the second terminal being the transfer destination, to the second terminal through the second carrier network; and
performing communication between the second terminal being the call destination which has received the second call-out request and the third terminal being the call origination source.
